(19) United States
(12) Patent Application Publication
(10) Pub. No.: US 2009/0327562 A1
(43) Pub. Date: Dec. 31, 2009

(54) Implementing Bus Interface Calibration for Enhanced Bus Interface Initialization Time

(75) Inventors: Mark David Bellows, Rochester, MN (US); Brian Patrick Burgess, Rochester, MN (US); John Dennis Folkerts, Rochester, MN (US); Roger John Gravrok, Eau Claire, WI (US); Brian Gerard Holthaus, Oronoco, MN (US); Murali N. Iyer, Rochester, MN (US); Christopher James Martin, Cincinnati, OH (US); Timothy Gerald Robeck, Rochester, MN (US); Dennis J. Spathis, Rochester, MN (US)

Correspondence Address: IBM CORPORATION;ROCHESTER IP LAW DEPT 917, 3605 HIGHWAY 52 N, ROCHESTER, MN, 55901-7829, US

(73) Assignee: INTERNATIONAL BUSINESS MACHINES CORPORATION, Armonk, NY (US)

(21) Appl. No.: 12/145,761

(22) Filed: Jun. 25, 2008

(51) Int. Cl. G06F 13/00

(52) U.S. Cl. 710/305

(57) ABSTRACT

A method and apparatus are provided for implementing bus interface calibration to improve bus interface initialization time in a system. Bus interface calibration is performed and average calibration values are saved. At bus interface initialization time, checking for saved calibration values is performed. The saved calibration values are used and tested. When the saved calibration values pass the test, then the saved calibration values are used for system operation without performing any training steps.

### FIELD OF THE INVENTION

The present invention relates generally to the data processing field, and more particularly, relates to a method and apparatus for implementing bus interface calibration to improve bus interface initialization time in a processor system.

### DESCRIPTION OF THE RELATED ART

To boot a system, often each bit/wire of a bus interface needs to be calibrated, for both transmit and receive paths. The bus interface connects, for example, a processor chip to another processor chip, a memory module to a memory controller or a processor, a memory controller to another memory controller, or the like.

In general from a high level, the calibration technique for the bus interface includes writing known patterns and adjusting the clock to the ideal location relative to data, or alternatively adjusting the data with respect to the clock. As the clock or data is adjusted the known pattern will either pass or fail.

The ideal location for the clock is essentially the center of a data eye where the known pattern transitions from failing to pass and the pattern transitions from passing to failing. This method of finding the ideal location or phase is a time consuming process of moving the clock relative to data, or moving the data relative the clock, while observing the known data pattern.

Many systems, such as a system using an extreme data rate dynamic random access memory (XDR DRAM) or Rambus memory, the calibration must be performed every time the system is booted. A rigid training process is followed without implementing any potential for quickly booting. The time consuming process limits applications for the use of many systems.

A need exists for an effective mechanism for implementing bus interface calibration to improve bus interface initialization time in a processor system.

### SUMMARY OF THE INVENTION

A principal aspect of the present invention is to provide a method and apparatus for implementing bus interface calibration to improve bus interface initialization time in a processor system. Other important aspects of the present invention are to provide such method and apparatus for implementing bus interface calibration to improve bus interface initialization time in a processor system substantially without negative effect and that overcome many of the disadvantages of prior art arrangements.

In brief, a method and apparatus are provided for implementing bus interface calibration to improve bus interface initialization time in a processor system. Bus interface calibration is performed using saved calibration values as a seed and average calibration values are saved. At bus interface initialization time, checking for saved calibration values is performed. The saved calibration values are loaded and tested. When the saved calibration values pass the test, then the saved calibration values are used for system operation without performing any training steps.

In accordance with features of the invention, a processor unit performing the test of the saved calibration values detects a pattern that does not work, then a bus interface calibration using the current saved calibration values is performed and new average calibration values are saved. The new saved average calibration values are used at a next system boot.

In accordance with features of the invention, once a system has booted, responsive to identifying a predefined event, the bus interface is placed in an auto-calibration mode and bus interface calibration is performed to adjust clock settings to actual ideal while the system is up and running. The predefined event includes, for example, a detected data error on the bus, a periodic event, changing environmental conditions, such as when the device temperature has increased by a set value of 5° C., a threshold system activity level such as a low-activity period, a system call, and a user call.

In accordance with features of the invention, after booting the system, any delta from the original average calibration values are recomputed and stored into the average calibrations values. The stored average calibration values include an average calibration value for a center of a data eye, and respective average maximum and minimum calibration values for opposite sides of the data eye. The average calibration values are saved with corresponding environmental conditions, such as driver and receiver voltages and temperatures. The average calibration values are saved in nonvolatile system memory.

### BRIEF DESCRIPTION OF THE DRAWINGS

The present invention together with the above and other objects and advantages may best be understood from the following detailed description of the preferred embodiments of the invention illustrated in the drawings, wherein:

FIG. 1 is a block diagram representations illustrating an exemplary processor system for implementing bus interface calibration to improve bus interface initialization time in accordance with the preferred embodiment;

FIGS. 2, 3, and 4 are flow chart illustrating exemplary steps for implementing bus interface calibration to improve bus interface initialization time in accordance with the preferred embodiment;

FIG. 5 is a block diagram illustrating a computer program product in accordance with the preferred embodiment.

### DETAILED DESCRIPTION OF THE PREFERRED EMBODIMENTS

In accordance with features of the invention, a method is provided that implements optimized bus interface calibration to improve bus interface initialization time in a processor system. For example, the method provides substantial performance improvement in a system using extreme data rate dynamic random access memory (XDR DRAM) or Rambus memory. The method finds an average solution over many calibrations and uses the running-average solution to allow a system to boot quickly. A major advantage to this solution is that a system with near ideal bus interface calibrations data can be developed based upon an average without going through the time consuming process of actually training the bus interface.

In accordance with features of the invention, the method allows a system to utilize previously discovered bus interface calibration values or a function of those calibration values. The history of the bus interface calibrations has sufficient margin relative to the ideal settings in order to eliminate the need to calibrate each bit on every power up.

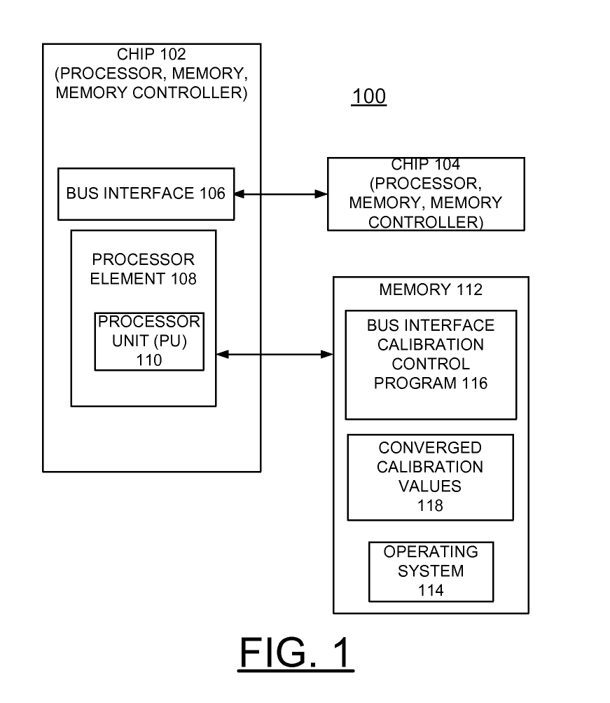

Referring now to the drawings, in FIG. 1 there is shown an exemplary system generally designated by the reference character 100 for implementing bus interface calibration to improve bus interface initialization time in accordance with the preferred embodiment. Computer system 100 includes a first chip 102, such as a processor, memory controller, or memory, coupled to a second chip 102, such as a processor, memory controller, or memory. The first chip 102 includes a bus interface 106 coupled to the second chip 104. The first chip 102 includes a processor element 108 including a processor unit (PU) 110.

System 100 includes a memory 112, such as a nonvolatile random access memory (NVRAM) 112. Computer system 100 includes an operating system 114, a bus interface calibration control program 116 of the preferred embodiment, and a plurality of converged calibration values 118 of the preferred embodiment resident in the memory 112.

Computer test system 100 is shown in simplified form sufficient for understanding the present invention. The illustrated computer test system 100 is not intended to imply architectural or functional limitations. The present invention can be used with various hardware implementations and systems and various other internal hardware devices.

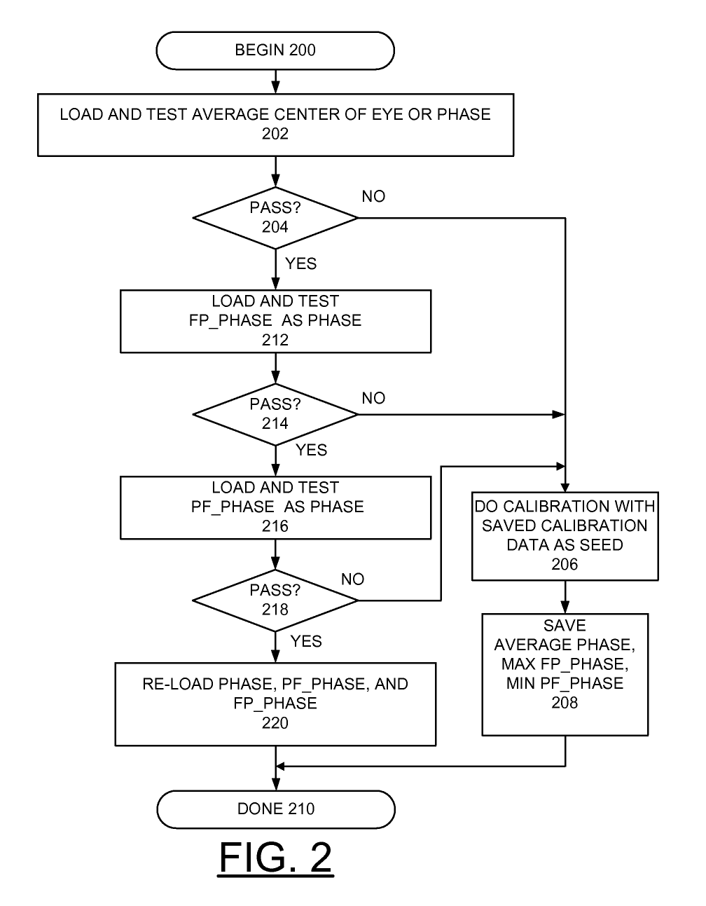

Referring now to FIGS. 2, 3, and 4, there are shown flow chart illustrating exemplary steps for implementing bus interface calibration to improve bus interface initialization time in accordance with the preferred embodiment.

In accordance with features of the invention, the method allows using stored average calibration values to be used as the calibration information or phase data to boot the system 100.

In accordance with features of the invention, the method tests the opposite minimum and maximum edges of the data eye to verify the stored calibration settings. Although this testing costs time, additionally robustness for the method of the preferred embodiment is gained. FIG. 2 outlines the steps necessary for verifying the settings. The PU 110 verifies the data eye settings based on reading and writing pattern to the chip 104.

Referring now to FIG. 2, there are shown exemplary steps for implementing optimized bus interface calibration in accordance with the preferred embodiment starting at a block 200. First an average center of the eye or phase calibration value is loaded and tested as indicated at a block 202. For example, the PU 110 of the cell processor 102 performs a store/read of a test pattern with error correcting code (ECC) enabled at block 202.

Checking whether the phase calibration value passes is performed as indicated at a decision block 204. If the phase calibration value fails, then a calibration is performed with the prior calibration values used as seed as indicated at a block 206.

In accordance with features of the invention, the method provides a history of successful configuration set points and the corresponding environmental conditions including driver and receiver voltages and temperatures in a large four-dimensional space for those set points so that, the next intelligently selected initial setpoints advantageously are calculated as a function of the present environmental conditions.

Then new average Phase, Max FP_Phase, and Min PF_Phase calibration values identified from the calibration process at block 206 are learned and stored for the next bus interface initialization or boot of the system 100 as indicated at a block 208.

The new average Phase, Max FP_Phase, and Min PF_Phase calibration values are saved with corresponding environmental conditions (e.g., driver and receiver voltages and temperatures at block 208. The Max FP_Phase, and Min PF_Phase calibration values represent respective opposite sides of the data eye. This completes the bus interface calibration process as indicated at a block 210.

Otherwise if the phase calibration value passes, then the stored FP_Phase is loaded and tested as the phase calibration value as indicated at a block 212. Checking whether the phase calibration value FP_Phase passes is performed as indicated at a decision block 214. If the phase calibration value fails, then the calibration is performed at block 206 and continues as described above.

If the phase calibration value FP_Phase passes, then checking the phase calibration value PF_Phase is loaded and tested as the phase calibration value as indicated at a block 216. Checking whether the phase calibration value PF_Phase passes is performed as indicated at a decision block 218. If the phase calibration value fails, then the calibration is performed at block 206 and continues as described above.

If the phase calibration value PF_Phase passes, then the phase calibration values Phase, PF_Phase, and FP_Phase are reloaded and the system 100 is ready for normal operations as indicated at a block 220. This completes the bus interface calibration process at block 210.

In accordance with features of the invention, the method enables that once the system 100 is running, the bus interface 106 can be placed in an auto-calibration mode to allow bus interface 106 to adjust its clock settings to actual ideal while the system is up and running. Then any delta from the original average calibration values are recomputed into the average calibrations settings and stored, for example, in nonvolatile random access memory (NVRAM) 112 or other system nonvolatile memory of system 100.

In accordance with features of the invention, the method enables building an autonomic database each time the interface re-calibrates itself, by storing the optimal setpoint conditions in conjunction to the environmental conditions. This enables novel pro-active use of the historical set points based upon their associated environmental conditions. Conversely, if the environmental conditions have not changed significantly, then a periodic re-calibration event advantageously is ignored to increase system availability and performance.

In accordance with features of the invention, the combination of valid setpoints and environmental conditions advantageously is used preemptively to initiate a new re-calibration event in response to a detected error, or a changing environmental conditions. Pre-emptive in that, if the device temperature has increased by, for example, 5° C., this indicates that the bus needs to be re-calibrated now, and should begin re-calibration using initial values (that may be optimal based on learned history) at a given set point. Another embodiment of pre-emptive calibrations is provided responsive to monitoring system activity, and the periodic re-calibration sequence is initiated during a low-activity period. A third preemptive re-calibration is initiated from a system, or user call. The pre-emptive methodologies yield higher performance and more reliability enabling to keep the bus optimally performing, rather than passively waiting for some preset period.

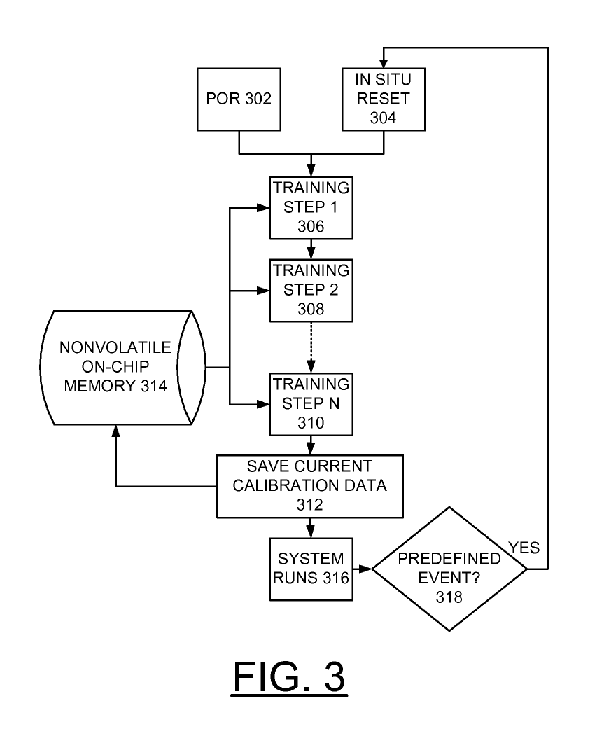

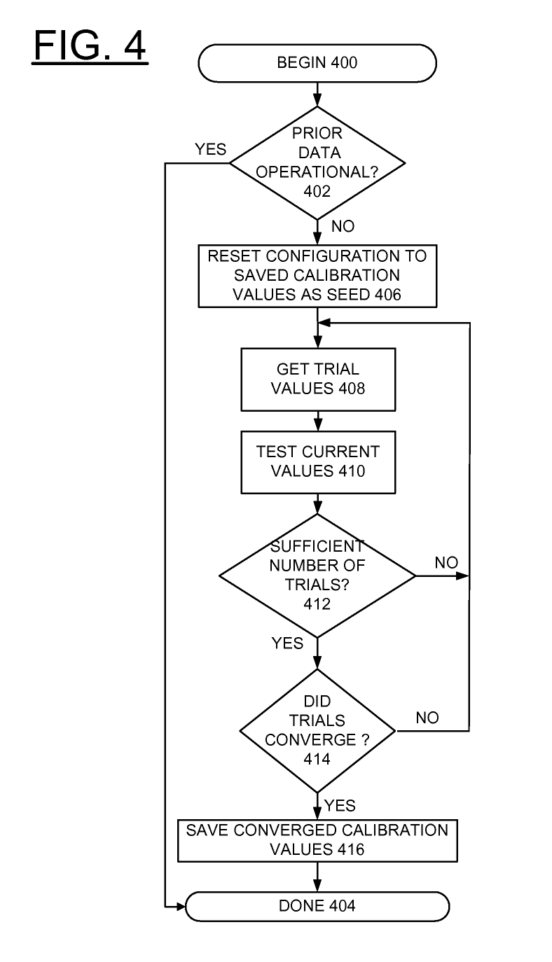

Referring now to FIG. 3, there are shown exemplary steps for implementing optimized bus interface calibration in accordance with the preferred embodiment starting with power on reset (POR) at a block 302 or in situ reset at a block 304. A first training step, such as generally illustrated and described in FIG. 4, is performed as indicated at a block 306. Then a second training step 2 is performed as indicated at a block 308, and then additional training steps are repeated through a training step N that is performed as indicated at a block 310. Current calibration data are saved as indicated at a block 312, and also saved in nonvolatile random access memory (NVRAM) 112 or other system nonvolatile memory of system 100 as indicated at a block 314. The nonvolatile random access memory (NVRAM) 112 or other system nonvolatile memory of system 100 provides the saved calibration data to each of the training steps 1-N, as illustrated in FIG. 3. The system runs as indicated at a block 316, and continues until a predefined event is identified as indicated at a decision block 318, then returning to the in situ reset at block 304. For example, the predefined event includes, for example, a detected data error, a periodic event, changing environmental conditions, such as when the device temperature has increased by a set value of 5° C., when system activity includes a low-activity period, and in response to a system call, or user call.

Referring now to FIG. 4, there are shown exemplary steps of training for implementing optimized bus interface calibration in accordance with the preferred embodiment starting with a block 400. Checking is performed to determine whether the prior calibration data is operational as indicated at a decision block 402. When the prior calibration data is operational, then the training is completed as indicated at a block 404.

When the prior calibration data is not operational, then as indicated at a block 406 the configuration is reset to use saved calibration values as seed as described above. Next trial values are obtained as indicated at a block 408. The current values are tested as indicated at a block 410. Checking for a sufficient number of trials is performed as indicated at a decision block 412. When a sufficient number of trials is not identified, then new trial values are obtained as indicated at a block 408, and the steps are repeated as described above.

When a sufficient number of trials is identified, then checking whether the trials converge is performed as indicated at a decision block 414. When the trials do not converge, then new trial values are obtained as indicated at a block 408, and the steps are repeated as described above. Otherwise when the trials converge, then the converged calibration values are saved as indicated at a block 416. This completes the training at block 404.

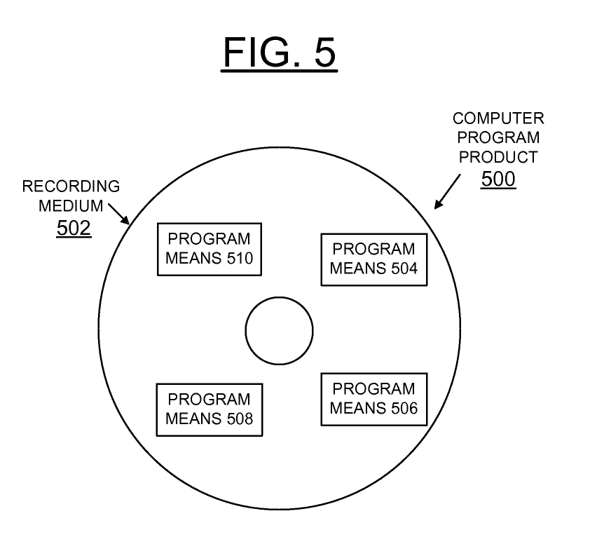

Referring now to FIG. 5, an article of manufacture or a computer program product 500 of the invention is illustrated. The computer program product 500 includes a recording medium 502, such as, a floppy disk, a high capacity read only memory in the form of an optically read compact disk or CD-ROM, a tape, or another similar computer program product. Recording medium 502 stores program means 504, 506, 508, 510 on the medium 502 for carrying out the methods for implementing bus interface calibration for improved bus interface initialization time of the preferred embodiment in the system 100 of FIG. 1.

A sequence of program instructions or a logical assembly of one or more interrelated modules defined by the recorded program means 504, 506, 508, 510, direct the system 100 for implementing bus interface calibration of the preferred embodiment.

While the present invention has been described with reference to the details of the embodiments of the invention shown in the drawing, these details are not intended to limit the scope of the invention as claimed in the appended claims.

What is claimed is:

1. A method for implementing bus interface calibration in a processor system comprising:
at bus interface initialization time, checking for saved calibration values;
responsive to identifying saved calibration values, testing the saved calibration values; and
responsive to the saved calibration values passing the test, using the saved calibration values for system operation without performing any memory training steps.

2. The method for implementing bus interface calibration as recited in claim 1 includes performing a bus interface calibration using saved calibration values as a seed and saving average calibration values.

3. The method for implementing bus interface calibration as recited in claim 2 wherein saving average calibration values includes saving an average calibration value for a center of a data eye, and respective average maximum and minimum calibration values for opposite sides of the data eye.

4. The method for implementing bus interface calibration as recited in claim 2 wherein saving average calibration values includes saving average calibration values together with corresponding predefined environmental condition values, said corresponding predefined environmental condition values including temperature.

5. The method for implementing bus interface calibration as recited in claim 1 wherein testing the saved calibration values includes identifying a failing pattern, and performing a bus interface calibration using saved average calibration values as seed, and saving new average calibration values.

6. The method for implementing bus interface calibration as recited in claim 5 includes using the new saved average calibration values at a next bus interface initilization.

7. The method for implementing bus interface calibration as recited in claim 1 further includes identifying a predefined event and placing the bus interface in an auto-calibration mode.

8. The method for implementing bus interface calibration as recited in claim 7 includes performing bus interface calibration while the system is running.

9. The method for implementing bus interface calibration as recited in claim 8 includes identifying a delta from the saved average calibration values and computing the delta into the average calibrations values, and saving the new average calibrations values.

10. The method for implementing bus interface calibration as recited in claim 7 wherein identifying a predefined event includes detecting one of a data error or a threshold system activity level including a low-activity period.

11. The method for implementing bus interface calibration as recited in claim 7 wherein identifying a predefined event includes identifying one of a system call, and a user call.

12. The method for implementing bus interface calibration as recited in claim 7 wherein identifying a predefined event includes identifying a predefined change in environmental conditions; said predefined change in environmental conditions including an set increase in device temperature.

13. An apparatus for implementing bus interface calibration in a processor system comprising:
a nonvolatile memory storing average calibration values;
a bus interface calibration control program embodied in a machine readable storage medium and checking for saved calibration values at bus interface initialization time,
said bus interface calibration control program responsive to identifying saved calibration values, testing the saved calibration values; and
said bus interface calibration control program responsive to the saved calibration values passing the test, using the saved calibration values for system operation without performing any bus interface training steps.

14. The apparatus for implementing bus interface calibration in a processor system as recited in claim 13 wherein said bus interface calibration control program performs a bus interface calibration using saved calibration values as seed, and saves new average calibration values.

15. The apparatus for implementing bus interface calibration in a processor system as recited in claim 14 wherein said bus interface calibration control program saving said new average calibration values includes said bus interface calibration control program saving said average calibration values together with corresponding predefined environmental condition values, said corresponding predefined environmental condition values including temperature.

16. The apparatus for implementing bus interface calibration in a processor system as recited in claim 14 wherein said bus interface calibration control program saving said new average calibration values includes said bus interface calibration control program saving an average calibration value for a center of a data eye, and respective average maximum and minimum calibration values for opposite sides of the data eye.

17. The apparatus for implementing bus interface calibration in a processor system as recited in claim 13 wherein said bus interface calibration control program responsive to identifying a failing pattern while testing the saved calibration values, performs a bus interface calibration, and saves new average calibration values.

18. The apparatus for implementing bus interface calibration in a processor system as recited in claim 13 wherein said bus interface calibration control program identifies a predefined event and places the bus interface in an auto-calibration mode.

19. The apparatus for implementing bus interface calibration in a processor system as recited in claim 18 wherein said bus interface calibration control program responsive to placing the bus interface in the auto-calibration mode, performs bus interface calibration while the system is running.

20. The apparatus for implementing bus interface calibration in a processor system as recited in claim 18 wherein said bus interface calibration control program identifying a predefined event includes said bus interface calibration control program detecting a data error condition; or identifying predefined change in environmental conditions; said predefined change in environmental conditions including an set increase in device temperature.
